(19) United States
(12) Patent Application Publication
(10) Pub. No.: US 2026/0257601 A1
(43) Pub. Date: Sep. 3, 2026

(54) Combined Thermal and Pneumatic System For a Vehicle Seat

(71) Applicant: GENTHERM INCORPORATED, Novi, MI (US)

(72) Inventors: Eric Santos, Essex (CA); Luke Andrew Boeve, Royal Oak, MI (US); Mike Pincheck, Farmington Hills, MI (US); Andrew Charles White, Greenville, SC (US); Randy Kent Lewis, Greenville, SC (US); Igor Spasojevic, Belle River (CA)

(21) Appl. No.: 19/163,001

(22) PCT Filed: Apr. 17, 2024
(86) PCT No.: PCT/US2024/024920

§ 371 Date: Sep. 8, 2025

Related U.S. Application Data
(60) Provisional application No. 63/462,585, filed on Apr. 28, 2023.

(51) Int. Cl. B60N 2/56; B60N 2/66; B60N 2/90

(52) U.S. Cl. CPC B60N 2/5657; B60N 2/665; B60N 2/914; B60N 2/976

(57) ABSTRACT

A comfort system for a vehicle seat that includes a thermal system having a bag structure, the bag structure having a top layer, an opposing bottom layer, and an air mover that is configured to push or pull air into or out of the bag structure to be distributed through one or more ventilation apertures defined in the top layer; and a pneumatic system located within the bag structure.

### CROSS-REFERENCE TO RELATED APPLICATIONS

This application is a National Stage Entry of PCT/US2024/024920 filed on Apr. 17, 2024, which claims the benefit of U.S. 63/462,585 filed on Apr. 28, 2023, the entireties of which are hereby incorporated by reference herein for all purposes.

### FIELD

These teachings relate to a comfort system for a vehicle seat, and more particularly to a combined thermal and pneumatic system for a vehicle seat.

### BACKGROUND

Some vehicle seats include one or more systems for improving occupant comfort. For example, some vehicle seats include one or more thermal systems to provide heating and/or cooling functions to an occupant of the vehicle seat. Some vehicle seats include one or more pneumatic systems to provide massage and/or lumbar functions to an occupant of the vehicle seat. While consumers enjoy such systems, they may undesirably complicate vehicle seat design; may require multiple systems to be supplied to a vehicle seat manufacturer from multiple vendors; and/or may complicate vehicle seat assembly. It may therefore be desirable to improve the current state of the art.

For example, it may be advantageous to reduce the number of separate or individual systems in a vehicle seat, without reducing the number of comfort amenities available in the vehicle seat. It may be desirable to combine certain comfort systems to reduce the number of separate systems that must be handled and installed in a vehicle seat.

### SUMMARY

These teachings provide a comfort system for a vehicle seat. The comfort system according to these teachings may include a thermal system and a pneumatic system. The thermal system and the pneumatic system may be combined or connected together to form a comfort system. The comfort system according to these teachings may advantageously reduce the number of separate or individual systems in a vehicle seat, without reducing the number of comfort amenities available in the vehicle seat.

These teachings provide a comfort system for a vehicle seat that includes a thermal system having a bag structure, the bag structure having a top layer, an opposing bottom layer, and an air mover that is configured to push or pull air into or out of the bag structure to be distributed through one or more ventilation apertures defined in the top layer; and a pneumatic system located within the bag structure. In some configurations, the air mover may also, or may instead, be configured to pull or draw air into and then out of the bag structure. The comfort system may also include one or more additional layers, which may provide additional comfort, such as a heating layer or mat configured to generate heat, a spacer layer to provided additional padding and/or reduce or prevent read through to the A-surface of the vehicle seat, or both.

### BRIEF DESCRIPTION OF THE DRAWINGS

FIG. 1 is a side view of a vehicle that includes a vehicle seat.

FIG. 2 is a perspective view of a vehicle seat that includes one or more comfort systems.

FIG. 3 is a perspective view of a thermal system.

FIG. 4 is a front view of a pneumatic system.

FIG. 5 is a schematic view of a comfort system.

FIG. 6 is a schematic view of a comfort system.

FIG. 7 is a schematic view of a comfort system.

FIG. 8 is a schematic view of a comfort system.

FIG. 9 is a schematic view of a comfort system.

FIG. 10 is a schematic view of a comfort system.

FIG. 11 is a schematic view of a comfort system.

FIG. 12 is a schematic view of a comfort system.

FIG. 13 is a schematic view of a comfort system.

FIG. 14 is a schematic view of a comfort system.

### DETAILED DESCRIPTION

These teachings provide a comfort system. The comfort system may be an insert or assembly that comprises two or more comfort producing functions. The comfort system may be a combination of two or more systems that are typically installed as individual components in a vehicle seat. For example, the comfort system may comprise a pneumatic system (massage and/or lumber system) and a thermal system such as a heating system and/or a cooling system, Advantageously, the comfort system according to these teachings may be assembled and then installed in a vehicle seat in one installation process as opposed to two or more individual steps or processes.

The comfort system according to these teachings may be assembled or connected together off site or off-line from the vehicle seat assembly location. Alternatively, the comfort system may be assembled or connected according to these teachings online before the comfort system is attached or installed in the vehicle seat. In some configurations, the attachment of the two systems or components of the system may take place before the comfort system is installed in the vehicle seat. Alternatively, the attachment of the two systems or components of the system may take place while the comfort system is installed in the vehicle seat or after the comfort system is installed in the vehicle seat.

Reference is made to the figures to illustrate the comfort system. It is understood that the examples in the figures is not exhaustive and features from one figure may be combined with features from another figure; features in a figure may be eliminated, repositioned, moved, or duplicated; or any combination thereof.

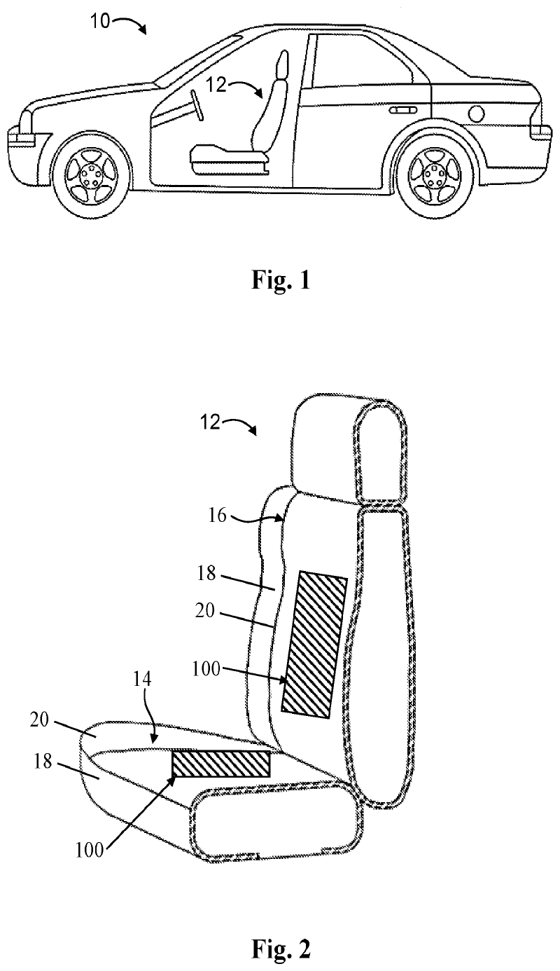

FIG. 1 illustrates a vehicle 10. The vehicle 10 comprises one or more vehicle seats 12.

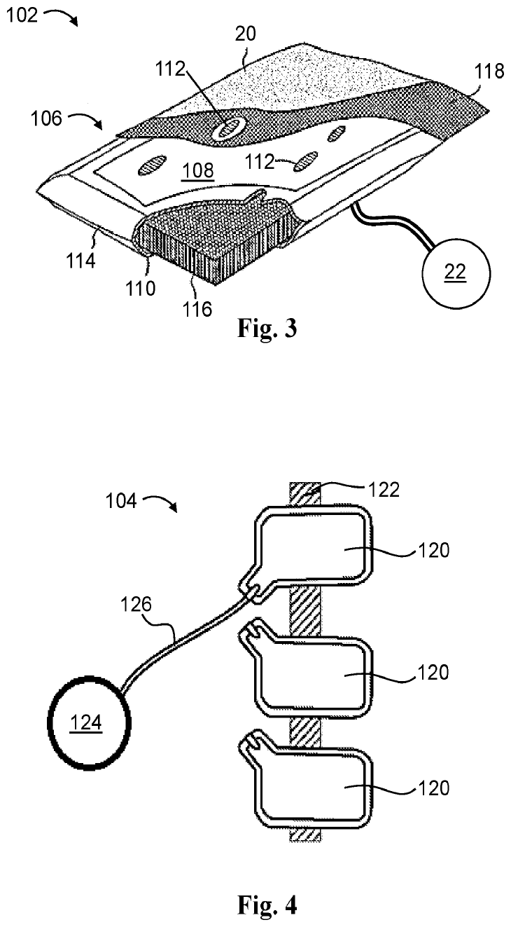

FIG. 2 illustrates a vehicle seat 12. The vehicle seat 12 comprises a seating portion 14 and a backrest portion 16. The seating portion 14 and the backrest portion 16 may include a cushion 18. The cushion 18 may be a single cushion for both portions 14, 16, or the cushion 18 may be two (or more) separate pieces. A cover or trim layer 20 may cover the cushion 18 and other components of the vehicle seat 12. The cover or trim layer 20 may be perforated leather, cloth, etc. The vehicle seat 12, the seating portion 14, and/or the backrest portion 16 may include one or more comfort systems 100. The comfort system 100 may include a thermal system 102 (FIG. 3) and a pneumatic system 104 (FIG. 4). The comfort system 100, the thermal system 102, and/or the pneumatic system 104 may be located between the cushion 18 and the cover or trim layer 20. The comfort system 100, the thermal system 102, and/or the pneumatic system 104 may be located on or at the A-side of the cushion 18 or at least partially within a recess defined in the A-side of the cushion 18. The comfort system 100, the thermal system 102, and/or the pneumatic system 104 may be located on or at the B-side of the cushion 18 or at least partially within a recess defined in the B-side of the cushion. The comfort system 100, the thermal system 102, and/or the pneumatic system 104 may be located within a thickness of the cushion 18, between the A-side and B-side of the cushion 18.

FIG. 3 illustrates a thermal system 102. The thermal system 102 may be of the type disclosed in U.S. Pat. No. 6,869,140 B2, the entirety of which is hereby incorporated by reference herein for all purposes. The thermal system 102 may include a bag structure 106 formed by a top layer 108 and a bottom layer 110. The bottom layer 110 may include one or more openings through which one or more blowers or air mover 22 may push or direct an air flow into the bag structure. The blower or air mover 22 may be directly connected to the bottom layer 110 or may be connected thereto via one or more tubes, channels, ducts, etc. The top layer 108 may include one or more ventilation apertures 112 through which the air flow pushed or blown into the bag structure 106 can be exhausted or distributed. In some configurations, air may be pulled or drawn into the bag structure 106 through one or more ventilation apertures 112 and then exhausted from the bag structure 106. The top and bottom layers 108, 110 may be connected at their edges 114 to form a pocket, pouch or open space therebetween. A spacer layer 116 may be arranged within the pocket, pouch, or open space of the bag structure 106. A heating layer 118 may be provided on or over the bag structure 106, above the top layer 108 and below the cover or trim layer 20 of the vehicle seat. In some configurations, the heating layer 118 may be located within the bag structure 106. In some configurations, the heating layer 118 may also be the top layer 108 (i.e., the heating layer 118 may be the same as the top layer 108 and vice versa).

The thermal system 102 and/or the heating layer 118 may be configured to generate heat after power is supplied to the heating layer 118 from a power source. In some configurations, the air mover may push air through the bag structure 106 and/or heating layer 118 to direct the warmth generated by the heating layer 118 towards the occupant. In some configurations, the thermal system 102 may be configured to cool an occupant in the vehicle seat by passing or distributing an air flow through the trim layer 20 of the vehicle seat towards the occupant without the heating layer 118 being activated (i.e., not generating heat).

FIG. 4 illustrates the pneumatic system 104. The pneumatic system 104 may be of the type disclosed in U.S. Pat. No. 10,906,442 B2, the entirety of which is hereby incorporated by reference herein for all purposes. The pneumatic system 104 may include one or more air cells or bladders 120 that are connected or supported on a carrier 122 via one or more fasteners. The air cells or bladders 120 may be connected to a fluid source 124 via one or more tubes 126. The fluid source 124 may be configured to supply a fluid through the one or more tubes 126 to inflate the one or more air cells or bladders 120. The air cells or bladders 120 may be deflated by removing or purging the fluid therefrom. The pneumatic system 104 may be a massage system, a lumbar system, or both.

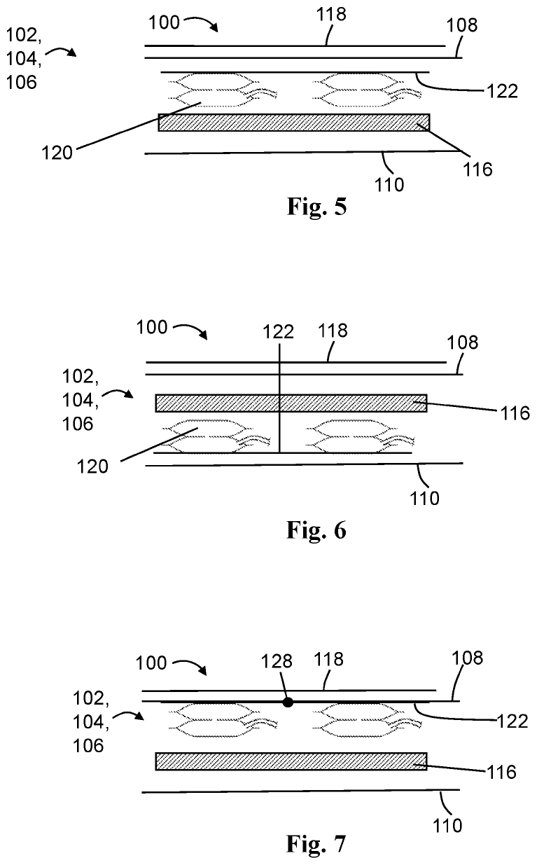

FIG. 5 illustrates a comfort system 100. The comfort system is illustrated schematically and as a partially exploded view. The comfort system 100 comprises a thermal system 102 and a pneumatic system 104. The pneumatic system 104 is located within the bag structure 106, above the spacer layer 116. The pneumatic system 104 is arranged such that the carrier 122 is adjacent to the top layer 108 and the one or more air cells 120 are arranged adjacent to the spacer layer 116. However, this orientation may be rotated such that the carrier 122 is arranged adjacent to the spacer layer 116 and the air cells 120 are adjacent to the top layer 108. In some configurations, a carrier 122 may be located on both sides of the air cells 120 (i.e., so that a carrier is arranged adjacent to the top layer 108 and the spacer layer 116 and the air cells 120 are in between the two carriers. The spacer layer 116 and the pneumatic system 104, including the carrier 122, may be free from any attachment to one another and/or to the upper and lower sheets 108, 110 of the bag structure 106. In this regard, the pneumatic system 104 and the spacer layer 116 may be free to move relative to each other and/or to the upper and lower sheets 108, 110. However, the open space or pouch formed between the two sheets 108, may be sufficiently small and/or snug to reduce or prevent substantial movement of the pneumatic system 104 and the spacer layer 116 within the pouch.

In some configurations, the bag structure 106 may be open at one or more ends or edges, as opposed to the bag structure 106 being sealed on all edges. Having one or more open ends or edges may provide advantages especially during assembly of the comfort system 100 to allow the components (i.e., pneumatic system 104, spacer layer 116, etc.) to be inserted into the pouch). After the components are installed or assembled between the layers 108, 110, the one or more open edges may be sealed or fastened closed before the system 100 is installed in a vehicle seat. Alternatively, the one or more open edges or ends may remain open or not fastened even after installation in the vehicle seat.

FIG. 6 illustrates a comfort system 100. The comfort system is illustrated schematically and as a partially exploded view. The comfort system 100 of FIG. 6 may be substantially similar to the system 100 illustrated and described above at FIG. 5. However, the pneumatic system 104 is located within the bag structure 106 of the thermal system 102, below the spacer layer 116. Again, the orientation in FIG. 6 may be flipped or rotated such that the carrier 122 is located adjacent to the spacer layer and the air cells 120 are arranged adjacent to the lower sheet 110.

FIG. 7 illustrates a comfort system 100. The comfort system is illustrated schematically and as a partially exploded view. The comfort system 100 of FIG. 7 may be substantially similar to the system 100 illustrated and described above at FIG. 5. However, the pneumatic system 104 may be arranged such that the carrier 122 is attached or connected to the top layer 108 via one or more fasteners 128. This may advantageously reduce or prevent the pneumatic system 104 from moving around within the bag structure 106. In some configurations, the carrier 122 may be omitted, and the air cells or bladders 120 may be connected directly to an inside surface of the top layer 108 via one or more fasteners. In some configurations, the top layer 108 may be eliminated and the carrier 122 may take the place of the top layer 108 to form the bag structure 106.

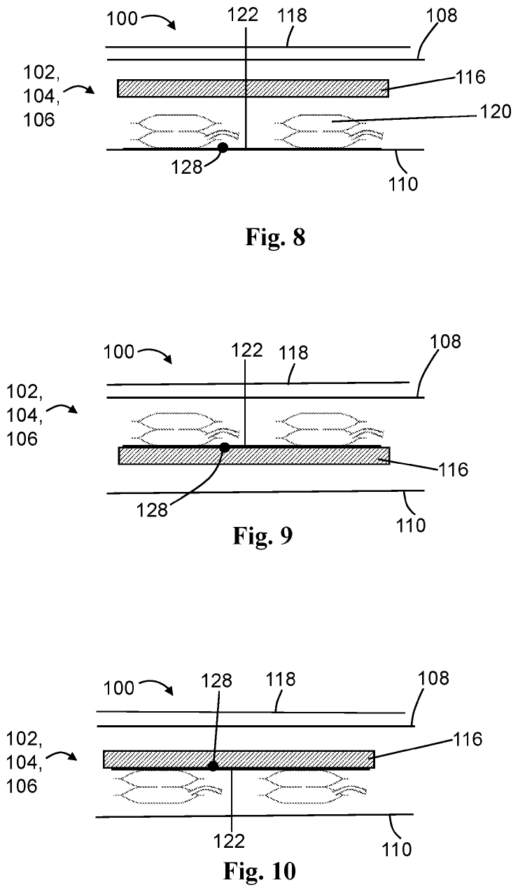

FIG. 8 illustrates a comfort system 100. The comfort system is illustrated schematically and as a partially exploded view. The comfort system 100 of FIG. 8 may be substantially similar to the system 100 illustrated and described above at FIG. 7. However, the pneumatic system 104 may be arranged such that the carrier 122 is attached or connected to the lower sheet 110 via one or more fasteners 128. This may advantageously prevent the pneumatic system 104 from moving within the bag structure 106. However, in some configurations the carrier 122 may be omitted, and the air cells or bladders 120 may be connected directly to an inside surface of the lower sheet 110. In some configurations, the lower sheet 110 may be eliminated and the carrier 122 may take the place of the lower sheet 110 to form the bag structure 106.

FIG. 9 illustrates a comfort system 100. The comfort system is illustrated schematically and as a partially exploded view. The comfort system 100 of FIG. 9 may be substantially similar to the system 100 illustrated and described above at FIG. 8. However, the pneumatic system 104 may be arranged such that the carrier 122 is attached or connected to a top side of the spacer layer 116 via one or more fasteners 128. This may advantageously prevent the pneumatic system 104 from moving within the bag structure 106 and/or relative to the spacer layer 116. In some configurations the carrier 122 may be omitted, and the air cells or bladders 120 may be connected directly to the spacer layer 116. In another configuration, the spacer layer 116 may be omitted and the carrier 122 may function as a spacer layer.

FIG. 10 illustrates a comfort system 100. The comfort system is illustrated schematically and as a partially exploded view. The comfort system 100 of FIG. 10 may be substantially similar to the system 100 illustrated and described above at FIG. 9. However, the pneumatic system 104 may be arranged such that the carrier 122 is attached or connected to the bottom side of the spacer layer 116 via one or more fasteners 128. In some configurations the carrier 122 may be omitted, and the air cells or bladders 120 may be connected directly to the spacer layer 116. In another configuration, the spacer layer 116 may be omitted and the carrier 122 may function as a spacer layer.

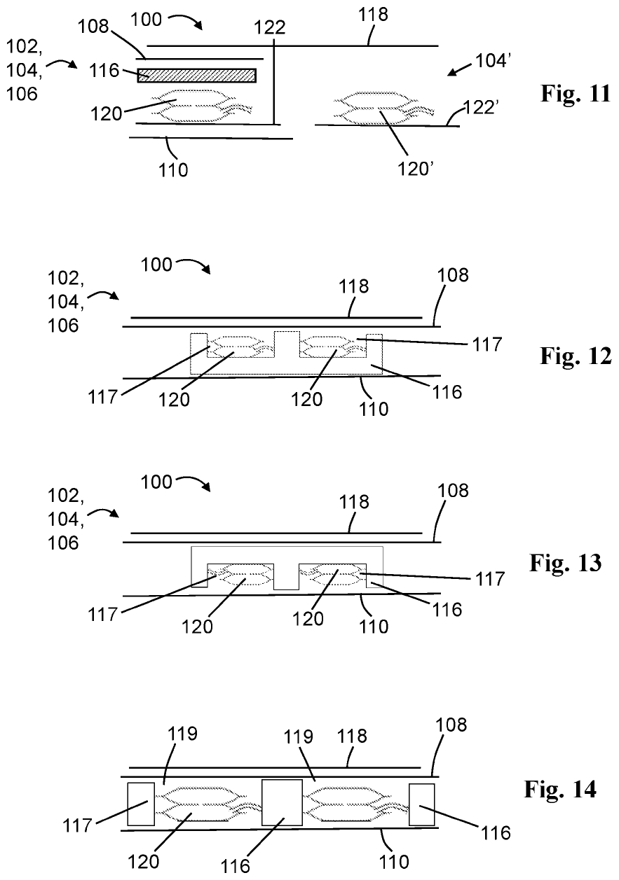

FIG. 11 illustrates a comfort system 100. The comfort system is illustrated schematically and as a partially exploded view. The comfort system 100 of FIG. 11 may be substantially similar to the system 100 illustrated and described above in FIGS. 5-10. In FIG. 11, however, a second pneumatic system 104′ is added to the system 100. The second pneumatic system 104′ is located outside of the bag structure 106. The second pneumatic system 104′ is located below the heating layer 118. Or a second, heating layer may be provided over the pneumatic system 104′. While not illustrated, a spacer layer 116 may be arranged above or below the pneumatic system 104′.

FIG. 12 and FIG. 13 illustrate a comfort system 100. The comfort system is illustrated schematically and as a partially exploded view. The comfort system 100 of FIG. 11 may be substantially similar to the system 100 illustrated and described in any of the previous figures. The spacer layer 116 may include one or more pockets or recesses 117. The one or more pockets or recesses 117 may be a minimized or absence of material of the spacer layer 116. The one or more pockets or recesses 117 may be formed by a material removing process (e.g., milling, cutting, melting, etc.). In other configurations, the one or more pockets or recesses 117 may be a region of the spacer layer 116 that is compressed, squeezed, or plastically deformed to create a thinner or reduced cross section in the pockets 117.

The one or more pockets or recesses may function to receive or accommodate one or more air cells or bladders 120 of the of the pneumatic system 104. In some configurations, the one or more pockets or recesses 117 may be sufficiently deep to accommodate an entire height of the one or more air cells 120 when the air cells are in an entirely or partially deflated configuration. In other configurations, the one or more pockets or recesses 117 may be sufficiently deep to accommodate only a portion of the height of the one or more air cells 120 when the air cells are in an entirely or partially deflated configuration so that a top surface of at least some of the air cells protrudes above other portions of the spacer layer 116 adjacent to the one or more pockets 117. The spacer layer 116 may function to bias at least a portion of the top layer 108 of the bag structure 106 away from the bottom layer 110 outwardly in areas surrounding the one or more air cells 116 to reduce read through of the air cells 116 through the cover or trim layer or A-surface of the vehicle seat.

The one or more air cells 116 may be connected or attached to one or more of the walls of the spacer layer 116 that are adjacent to the one or more pockets 117. The one or more air cells 116 may be connected or attached to the top layer 108, the bottom layer 110, or any other layer in the bag structure 106. In some configurations, the one or more air cells 116 may be free of a direct connection or attachment to the bag structure; instead, the one or more air cells may be arranged between the layers 108, 110 of the bag structure and the walls of the spacer layers 116 adjacent to the one or more pockets 117. In some configurations, the one or more air cells 116 may be provided on a carrier, like the carrier 122 described in the previous examples. In such configurations, the carrier 122 may be attached to one or more layers of the bag structure, like the top layer 108, the bottom layer 110, the spacer layer, etc. in other configurations, the carrier may be free from any direct attachment to the elements of the bag structure. In other configurations, the carrier may be omitted.

The open end of the one or more pockets or recesses may face the top layer 108 and/or the heating layer 118 arranged above the top layer 108. Additionally, or alternatively, referring now to FIG. 13, the one or more pockets or recesses 117 may be arranged to face the bottom layer 110 of the bag structure 106.

FIG. 14 illustrates a comfort system 100. The comfort system is illustrated schematically and as a partially exploded view. The comfort system 100 of FIG. 14 may be substantially similar to the system 100 illustrated and described in any of the previous figures. The spacer layer 116 may include one or more through holes or cutouts 119 The one or more through holes or cutouts 119 may be a complete absence of material of the spacer layer 116. The one or more through holes or cutouts 119 may be formed by a material removing process (e.g., milling, cutting, melting, etc.).

The one or more through holes or cutouts 119 may function to receive, support, or accommodate one or more air cells or bladders 120 of the of the pneumatic system 104. In some configurations, the one or more through holes or cutouts 119 may be sufficiently deep to accommodate an entire height of the one or more air cells 120 when the air cells are in an entirely, or a partially, deflated configuration. In other configurations, the one or more through holes or cutouts 119 may be sufficiently deep to accommodate only a portion of the height of the one or more air cells 120 when the air cells are in an entirely or partially deflated configuration so that a top surface of at least some of the air cells protrudes or extends above other portions of the spacer layer 116 adjacent to the one or more through holes or cutouts 119. The spacer layer 116 may function to bias at least a portion of the top layer 108 of the bag structure 106 outwardly way from the bottom layer 110 of the bag structure 106 in areas surrounding the one or more air cells 116 to reduce read through of the air cells 120 through the cover or trim layer or A-surface of the vehicle seat.

The one or more air cells 116 may be connected or attached to one or more of the walls of the spacer layer 116 that are adjacent to the one or more through holes or cutouts 119. The one or more air cells 116 may be connected or attached to the top layer 108, the bottom layer 110, or any other layer in the bag structure 106. In some configurations, the one or more air cells 116 may be free of a direct connection or attachment to the bag structure; instead, the one or more air cells may be arranged between the layers 108, 110 of the bag structure and the walls of the spacer layers 116 adjacent to the through holes or cutouts 119. In some configurations, the one or more air cells 116 may be provided on a carrier, like the carrier 122 described in the previous examples. In such configurations, the carrier 122 may be attached to one or more layers of the bag structure, like the top layer 108, the bottom layer 110, the spacer layer, etc. in other configurations, the carrier may be free from any direct attachment to the elements of the bag structure. In other configurations, the carrier may be omitted.

The following is a description of the elements of the comfort system which may apply to all examples disclosed herein.

The bag structure may be comprised of one or more top and bottom layer or sheets that are joined or fastened together via one or more fasteners. The top and bottom layers may be air permeable or air impermeable. The top sheet may include one or more ventilation apertures through which air blown or pushed in the bag structure can be expelled. In some configurations, the one or more ventilation apertures can be used for drawing air into the bag structure. The bottom sheet may include one or more apertures through which air may be blown or pushed into the bag structure from one or more blowers or air movers. In some configurations, the one or more apertures in the bottom sheet can be used for expelling air from the bag structure. The layers or sheets may be joined together with one or more fasteners disclosed herein. The bag structure may contain some or all of the elements of the comfort system disclosed herein. Accordingly, a user or operator may handle and install a single assembly that comprises multiple comfort devices, thereby reducing installation time and increasing efficiencies. Further, risk of omitting a comfort system (thermal or pneumatic) or incorrectly installing one system is reduced or eliminated.

The comfort system according to these teachings comprises one or more spacer layers. A spacer layer may function to reduce read through or visibility of one or more elements or components of the comfort system through an A-surface of the vehicle seat. The spacer layer may function to provide additional padding and or support to an occupant in the vehicle seat. The spacer layer may be sufficiently thick to provide padding and additional comfort to the occupant and reduce read through of any of the comfort functions through an A side of the vehicle seat, however, so as to not interfere with any massage or lumbar functions of the pneumatic system. The spacer layer may function to change modify the feel of the seat, increase, or decrease an intensity of the massage or lumbar functions of the pneumatic system that is seen and/or felt by an occupant, or both. The spacer layer may be an air permeable material or layer. The spacer layer may function to facilitate an even distribution of air flow. The spacer layer may be an air impermeable material or layer. The spacer layer may be made of a cloth, fleece, and/or felt material, spun bond material, polyester material, a PET material (polyethylene terephthalate), a foam, a plush foam, or a combination thereof. The spacer layer may be felt or similar, or spacer fabric such as that supplied by Mueller Textile of Germany.

The spacer layer may be configured to generally retain its three-dimensional shape when subjected to compressive and/or other types of forces. The spacer layer may include internal pores or passages that permit air or other fluid to pass therethrough. For example, the spacer layer can comprise an internal lattice or other structure which has internal openings. The spacer layer may be a screen or a mesh. The spacer layer may be compressible, elastic, resilient, or a combination thereof. The spacer layer may be breathable, resistant to crushing, and/or made from a foam, plastic, and/or polymeric material. The spacer layer may have sufficient resiliency to prevent crushing of spacer layer when an occupant sits on or leans back against the vehicle seat. The spacer layer may include an upper netting layer, a lower netting layer and a plurality of fibers extending between them. The spacer layer may be a heating layer.

Reference is made herein to using one or more fasteners herein. The one or more fasteners may be used for attaching or connecting the one or more air bladders or cells to the carrier of the pneumatic system; for attaching or connecting the carrier of the pneumatic system to one or more layers of the bag structure; for connecting one or more layers of the bag structure to one another; for connecting the spacer layer the one or more carriers and/or layers of the bag structure; for connecting or attaching the comfort system to the vehicle seat or seat foam; etc.

The one or more fasteners may be or may include one or more fastening components and/or fastening methods that include: lamination, tape, double-sided adhesive tape, single sided adhesive tape, pressure sensitive adhesive, glues, epoxies, hog rings, stitching, sewing, welding, high-frequency welding, IR welding, RF welding, ultrasonic welding, sealing, heat sealing, heat staking, chemical fixation, hook and loop fasteners, staples, rivets, pins, buttons, snaps, bands, straps, or a combination thereof.

It is understood that any of the layers disclosed herein may be eliminated, duplicated, rearranged, and/or combined with other layers. For example, while not illustrated, a second spacer layer may be arranged between the pneumatic system 104 and the top layer 108 in FIG. 7. Additionally, features from one figure may be combined with features from another figure. For example, in FIG. 11, it is within the scope of this disclosure that the pneumatic system 104 is connected to the top layer 108, the bottom layer 110, and/or the spacer layer 116.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps. For example, disclosure of “a motor” does not limit the teachings to a single motor. Instead, for example, disclosure of “a motor” may include “one or more motors.”

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The invention illustratively disclosed herein may suitably be practiced in the absence of any element which is not specifically disclosed herein.

Any of the elements, components, regions, layers and/or sections disclosed herein are not necessarily limited to a single embodiment. Instead, any of the elements, components, regions, layers and/or sections disclosed herein may be substituted, combined, and/or modified with any of the elements, components, regions, layers and/or sections disclosed herein to form one or more embodiments that may be or may not be specifically illustrated or described herein.

The disclosures of all articles and references, including patent applications and publications, testing specifications, are incorporated by reference for all purposes. Other combinations are also possible as will be gleaned from the following claims, which are also hereby incorporated by reference into this written description.

Listing of Reference Numerals

| | |
|---|---|
| 10 | vehicle |
| 12 | vehicle seat |
| 14 | seating portion |
| 16 | backrest portion |
| 18 | cushion |
| 20 | cover or trim layer |
| 22 | air mover |
| 100 | comfort system |
| 102 | thermal system |
| 104 | pneumatic system |
| 106 | bag structure |
| 108 | top layer of bag structure 106 |
| 110 | bottom layer of bag structure 106 |
| 112 | ventilation aperture in top layer 108 of bag structure 106 |
| 114 | edges of top and bottom layers 108, 110 of bag structure 106 |
| 116 | spacer layer |
| 117 | pockets or recesses in spacer layer 116 |
| 119 | through holes or cutouts in spacer layer 116 |
| 118 | heating layer |
| 120 | air cells or bladders of pneumatic system 104 |
| 122 | carrier of pneumatic system |
| 124 | fluid source |
| 126 | tube |
| 128 | fasteners |

1. A comfort system for a vehicle seat, comprising:
a thermal system comprising a bag structure, the bag structure comprising a top layer, an opposing bottom layer, and an air mover that is configured to push air into the bag structure to be distributed through one or more ventilation apertures defined in the top layer; and
a pneumatic system located within the bag structure.

2. The comfort system according to claim 1, wherein the thermal system comprises a spacer layer located within the bag structure, wherein the spacer layer is an air permeable layer.

3. The comfort system according to claim 2, wherein the spacer layer comprises a pocket or recess into which at least part of the pneumatic system is located.

4. The comfort system according to claim 2, wherein the spacer layer comprises a through hole or cutout into which at least part of the pneumatic system is located.

5. The comfort system according to claim 1, wherein the pneumatic system comprises a carrier and one or more air cells connected to the carrier.

6. The comfort system according to claim 5, wherein the spacer layer is arranged adjacent to the bottom layer of the bag structure, the carrier of the pneumatic system is located adjacent to the top layer of the bag structure, and the one or more air cells are arranged adjacent to the spacer layer.

7. The comfort system according to claim 6, wherein the carrier is connected to the top layer via one or more fasteners.

8. The comfort system according to claim 5, wherein the spacer layer is arranged adjacent to the top layer of the bag structure, the carrier of the pneumatic system is located adjacent to the bottom layer of the bag structure, and the one or more air cells are arranged adjacent to the spacer layer.

9. The comfort system according to claim 8, wherein the carrier is connected to the bottom layer via one or more fasteners.

10. The comfort system according to claim 5, wherein the spacer layer is arranged adjacent to the bottom layer of the bag structure, the carrier of the pneumatic system is located adjacent to a top side of the carrier, and the one or more air cells are arranged adjacent to the top layer.

11. The comfort system according to claim 8, wherein the carrier is connected to the spacer layer via one or more fasteners.

12. The comfort system according to claim 5, wherein the spacer layer is arranged adjacent to the top layer of the bag structure, the carrier of the pneumatic system is located adjacent to a bottom side of the carrier, and the one or more air cells are arranged adjacent to the top layer.

13. The comfort system according to claim 12, wherein the carrier is connected to the spacer layer via one or more fasteners.

14. The comfort system according to claim 1, wherein the comfort system comprises a heating layer provided over the top surface of the bag structure.

15. The comfort system according to claim 1, wherein the comfort system comprises a second pneumatic system that is located outside of the bag structure and below the heating layer.

16. The comfort system according to claim 1, wherein the pneumatic system is a lumbar system and/or a massage system.

17. The comfort system according to claim 1, wherein the comfort system is arranged at the A-side of a cushion of the seat.

18. The comfort system according to claim 1, wherein the comfort system is arranged at the B-side of a cushion of the vehicle seat.

19. The comfort system according to claim 1, wherein the comfort system is arranged within a thickness of a cushion of the seat, between an A-side of the cushion and a B-side of the cushion.

20. A method of making the comfort system according to claim 1, wherein the method comprises:
inserting the pneumatic system into the bag structure, the pneumatic system is a massage system and/or a lumbar system;
attaching the carrier of the pneumatic system to one or more layers or sheets of the bag structure;
and either:
i) the method comprises a step of attaching the carrier of the pneumatic system to the spacer layers inside of the bag structure; or
ii) the method is free of any step of attaching or connecting the pneumatic system to any layers of the bag structure and/or a spacer layer inside of the bag structure.
